(19) United States
(12) Patent Application Publication
(10) Pub. No.: US 2007/0218282 A1
(43) Pub. Date: Sep. 20, 2007

(54) Hard-magnetic nanoparticles, manufacturing method therefor, magnetic fluid and magnetic recording medium

(75) Inventor: Satoru Momose, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/487,350

(22) Filed: Jul. 17, 2006

(30) Foreign Application Priority Data
Mar. 16, 2006 (JP) 2006-072231

(51) Int. Cl. B32B 5/16; B32B 15/00; G11B 5/65; G11B 5/708; B05D 5/12; B05D 3/10; B05D 3/02

(52) U.S. Cl. 428/402; 428/692.1; 428/836; 428/842; 427/127; 427/372.2; 427/336

(57) ABSTRACT

Hard-magnetic nanoparticles having a small particle size and an ordered crystal structure with a high magnetic anisotropic energy are provided together with a manufacturing method therefor, a magnetic fluid comprising a dispersion of the hard-magnetic particles, and a magnetic recording medium with an excellent S/N ratio. The method for manufacturing the hard-magnetic nanoparticles comprises the steps of causing metal nanoparticles to be adsorbed on a porous material, heat-treating the metal nanoparticles in a reducing atmosphere, and dissolving the porous material in a liquid capable of dissolving the porous material to isolate the hard-magnetic nanoparticles from the porous material.

### CROSS-REFERENCE TO RELATED APPLICATIONS

This application is based upon and claims the benefit of priority from the prior Japanese Patent Application No. 2006-72231, filed on Mar. 16, 2006, the entire contents of which are incorporated herein by reference.

### BACKGROUND OF THE INVENTION

1. Field of the Invention

The present invention relates to a magnetic recording medium of a magnetic disk device, and more particularly to a hard-magnetic material that is a recording material for a magnetic recording medium, and to a manufacturing method therefor.

2. Description of the Related Art

A rapid increase in the amount of information recorded on magnetic disk devices used as recording devices for computers and home video recorders has led to increased demands for larger capacities, higher speeds and lower costs. One of the most important keys for meeting these demands is to increase the recording densities of the magnetic recording media, and in the case of magnetic disk devices, recording densities are currently increasing by 100% a year.

To increase recording densities, it is necessary to decrease the size of the recording unit on the recording layer of the magnetic recording medium. To do this it is necessary to decrease the size of magnetic clusters that carry the recording unit. The smallest size of a magnetic cluster is equal to the physical size of a crystal forming the cluster or in other words to the crystal grain size. Consequently, researches have been done into reducing the crystal grain size by a variety of methods.

However, if the crystal grain size is simply reduced, the thermal stability declines, resulting in a loss of information recorded as magnetization. To ensure the thermal stability, it is necessary to increase the anisotropic energy to compensate for the loss of crystal grain volume due to the smaller size of the crystal grains.

Also in the in-plane recording system using a continuous magnetic film that has been popular, there is a problem that as the recording density increases, the signal-to-noise ratio decreases due to increased transition noise. Transition noise occurs due to exchange interactions and static magnetic interactions among the aforementioned crystal grains. These interactions are dependent on the distance between crystal grains and the variation in this distance.

To resolve these problems, hard-magnetic FePt nanoparticles that are formed by chemical methods and arrange themselves by self-alignment have been proposed {Japanese Patent Applications Laid-open Nos. 2000-48340 (Claims) and 2000-54012 (Claims.); Sun et al., Science 2000, Vol. 287, pp. 1989-1992}.

Because the anisotropic energy of these FePt nanoparticles is greater than that of conventional CoCrPt alloys, the thermal stability is ensured even at a smaller particle size, and the nanoparticles have an average particle size of 4 nm, a particle size distribution much smaller than that for conventional continuous metal film media, and they are arranged uniformly by self-alignment, so that the transition noise is expected to be less.

However, medium noise is not limited to transition noise, and, for example, in a perpendicular recording system if the axis of easy magnetization of the magnetic crystals in the recording film is not oriented perpendicular to the plane, an adequate S/N ratio will not be obtained. Consequently, the axis of easy magnetization of the FePt nanoparticles needs to be oriented even in a magnetic recording medium using FePt nanoparticles as the recording material.

One means that has been proposed for solving this orientation problem is to heat the FePt nanoparticles after they have been adsorbed on a carrier surface, thus converting a disordered fcc (face-centered cubic) structure with a low magnetic anisotropic energy into an ordered fct structure with a high magnetic anisotropic energy, after which the carrier is removed to manufacture FePt nanoparticles with an fct (face-centered tetragonal) structure {Japanese Patent Application Laid-open No. 2004-362746 (Claims)}.

However, with the technology described in Japanese Patent Application No. 2004-362746 (Claims) it was found difficult to achieve highly-ordered FePt nanoparticles while maintaining the same particle size of the FePt nanoparticles before and after regularization (or ordering). Specifically, of the disclosed examples, when a silica gel was used as a carrier the degree of ordering was inadequate, while when magnesium sulfate was used as a carrier the particle size of the nanoparticles was considerably larger.

### SUMMARY OF THE INVENTION

It is an object of the present invention to resolve these problems and to provide a technique for achieving hard-magnetic nanoparticles used for magnetic recording having an ordered structure with a high magnetic anisotropic energy while maintaining the small particle size. Other objects and advantages of the present invention will be made clear from the following explanation.

One aspect of the present invention provides hard-magnetic nanoparticles adsorbed on a porous material. The hard-magnetic nanoparticles preferably include at least one material selected from the group consisting of FePt, FePd and CoPt.

Another aspect of the present invention provides hard-magnetic nanoparticles that are the aforementioned hard-magnetic nanoparticles from which the porous material has been removed. The average particle size of the hard-magnetic nanoparticles is preferably 6 nm or less.

Hard-magnetic nanoparticles having a small particle size and an ordered structure with a high magnetic anisotropic energy are obtained by these two aspects of the present invention.

Yet another aspect of the present invention provides a method for manufacturing hard-magnetic nanoparticles, comprising:

causing metal nanoparticles to be adsorbed in a porous substrate;

heat-treating them in a reducing atmosphere; and then,

dissolving the porous material in a liquid capable of dissolving the porous material, thereby separating the hard-magnetic nanoparticles from the porous material.

This aspect of the present invention allows hard-magnetic nanoparticles to be manufactured having a small particle size and an ordered structure with a high magnetic anisotropic energy.

It is desirable that the aforementioned adsorption be accomplished by bringing the porous material into contact with metal nanoparticles dispersed in a liquid, that the ratio of the aforementioned metal nanoparticles to the aforementioned porous material be 1 part by mass of the aforementioned metal nanoparticles per 10 parts or more by mass of the aforementioned porous material, that the aforementioned heat-treated metal nanoparticles be placed together with the porous material in an aqueous solution capable of dissolving the porous material, after which the aqueous solution is brought into contact with a water-insoluble liquid and the metal nanoparticles are transferred to the water-insoluble liquid, that the aforementioned metal nanoparticles be nanoparticles having at least one material selected from the group consisting of FePt, FePd and CoPt, that the aforementioned porous material be a silica gel, that the aforementioned porous material be a zeolite, and that the aforementioned heat treatment be at a temperature of 400 to 900° C.

Yet another aspect of the present invention provides hard-magnetic nanoparticles fabricated by the aforementioned fabrication method, a magnetic fluid having the aforementioned hard-magnetic nanoparticles dispersed in a nonpolar liquid, and a magnetic recording medium obtained by applying the aforementioned hard-magnetic nanoparticles.

Hard-magnetic nanoparticles having a small particle size and an ordered structure with a high magnetic anisotropic energy, a magnetic fluid of dispersed hard-magnetic nanoparticles having a small particle size and an ordered structure with a high magnetic anisotropic energy, and a magnetic recording medium with an excellent S/N ratio are obtained by these three aspects of the present invention.

Hard-magnetic nanoparticles having a small particle size and an ordered structure with a high magnetic anisotropic energy and a magnetic fluid obtained by dispersing these excellent hard-magnetic nanoparticles are provided by the present invention. A magnetic recording medium with an excellent S/N ratio can be obtained using these hard-magnetic nanoparticles.

### BRIEF DESCRIPTION OF THE DRAWINGS

FIG. 1 is a schematic enlarged view showing adsorption of metal nanoparticles on a nanoparticle carrier;

FIG. 2 shows the x-ray diffraction pattern of the hard-magnetic nanoparticles of Example 1;

FIG. 3 is a transmission electron microscope image of the hard-magnetic FePt nanoparticles of Example 1;

FIG. 4 shows the particle size distribution of hard-magnetic FePt nanoparticles as obtained by analyzing the electron microscope image of FIG. 3;

FIG. 5 shows the x-ray diffraction pattern of the hard-magnetic nanoparticles of Example 2;

FIG. 6 is a transmission electron microscope image of the hard-magnetic FePt nanoparticles of Example 2; and

FIG. 7 shows the particle size distribution of hard-magnetic FePt nanoparticles as obtained by analyzing the electron microscope image of FIG. 6.

### DESCRIPTION OF THE PREFERRED EMBODIMENTS

Embodiments of the present invention are explained below using drawings, examples and the like. These drawings, examples and the like and explanations exemplify the present invention and do not limit its scope. Other embodiments are included in the scope of the present invention to the extent that they match the intent of the present invention.

The hard-magnetic nanoparticles of the present invention are prepared by a method comprising:

causing metal nanoparticles to be adsorbed on a porous material;

heat-treating the metal nanoparticles in a reducing atmosphere; and then,

dissolving the porous material in a liquid capable of dissolving the porous material to isolate the hard-magnetic nanoparticles from the porous material.

The hard-magnetic nanoparticles of the present invention include both hard-magnetic nanoparticles that are adsorbed on a porous material and hard-magnetic nanoparticles that have been subsequently isolated from the porous material.

In the present invention a “nanoparticle” is a nanometer-sized particle or more specifically a particle with an average particle size of 10 nm or less. The hard-magnetic nanoparticles of the present invention may be of any material exhibiting hard magnetism, but to be optimal for magnetic recording purposes they preferably comprise at least one material selected from the group consisting of FePt, FePd and CoPt, and more preferably consist of at least one material selected from the group consisting of FePt, FePd and CoPt.

FePt, FePd and CoPt are normally in alloy forms, but the form is not limited as long as it exhibits adequate hard magnetism for purposes of the present invention. Other elements may also be present as long as the hard magnetism is adequate. For example, a considerable amount of Si and/or Al may be included as impurities in the dispersion of FePt nanoparticles or the like, as will be explained later.

The “metal nanoparticles” of the present invention are nanoparticles that have not yet exhibited hard magnetism. However, if it is clear from context that they have acquired hard magnetism, they may be metal nanoparticles having hard magnetism or in other words hard-magnetic nanoparticles. The same applies to the material of the “metal nanoparticles”. There are no particular limits on the method of manufacturing the metal nanoparticles of the present invention, and a known method can be selected as appropriate. Magnetic particles with little variation in distance between crystal grains can be obtained using the metal nanoparticles.

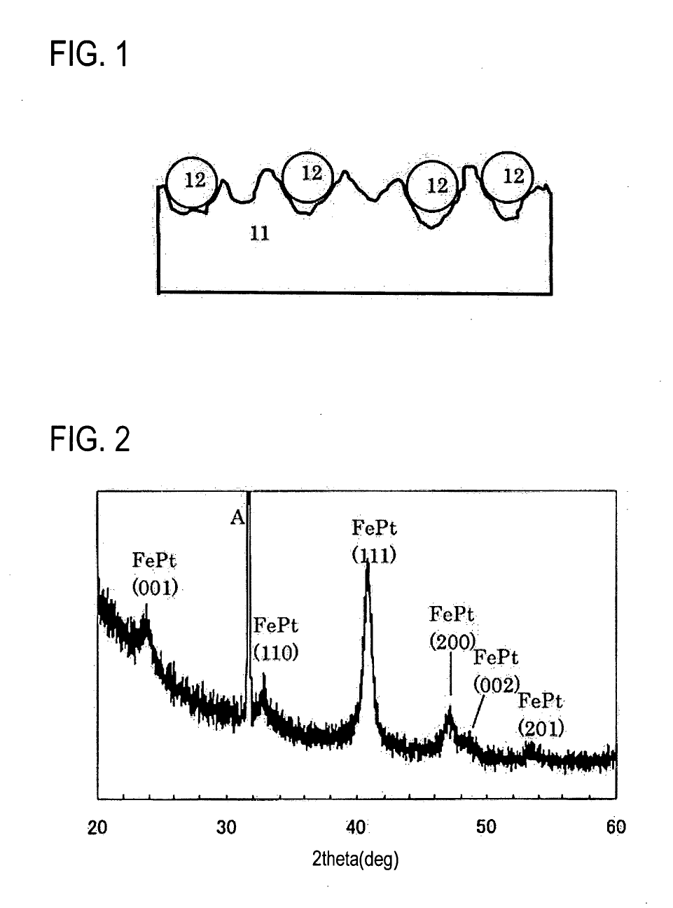

The hard-magnetic nanoparticles of the present invention that are adsorbed on a porous material are obtained by bringing a porous material into contact with metal nanoparticles dispersed in a suitable liquid. FIG. 1 shows metal nanoparticles 12 adsorbed by porous material 11. It is thought that adsorption probably occurs in this way, but other forms are also possible. The liquid used can be filtered to confirm that adsorption has occurred.

There are no particular limits on the porous material used in the present invention as long as it can be subsequently separated from the hard-magnetic nanoparticles, but from the standpoint of ease of dissolution in an alkali or acid material and ease of separation from the hard-magnetic nanoparticles, it is preferably a silica gel which is a porous amorphous silicon oxide or a zeolite which is a porous aluminosilicate. A zeolite is more preferable from the standpoint of ease of separation from the hard-magnetic nanoparticles.

There are no particular limits on the mass ratio of the porous material to metal nanoparticles in the present invention, but in general 10 parts or more by mass of the porous material are added to every 1 part by mass of the nanoparticles. Below this, too many of the particles are likely to fuse during heat treatment. There is no particular upper limit on the amount of the porous material added per 1 part by mass of the nanoparticles, but 400 parts by mass or less is preferable from the standpoint of handling the porous material that is a nanoparticle carrier and efficient use of the porous material.

There are no particular limits on the liquid for dispersing the metal nanoparticles, which may be a nonpolar liquid such as hexane or another hydrocarbon.

When the metal nanoparticles adsorbed on a porous material have been dispersed in a liquid as described above, the liquid is removed by filtration, evaporation or the like, and heat treatment is applied to confer hard magnetism. Hard-magnetic nanoparticles adsorbed on a porous material are obtained by this heat treatment.

This heat treatment brings about crystal ordering to metal nanoparticles obtained by chemical synthesis or the like and lacking crystal ordering, thereby providing hard-magnetic nanoparticles. For example, the disordered fcc structure of FePt nanoparticles can be converted to an ordered fct structure. Moreover, the particle size of the hard-magnetic nanoparticles can be prevented from being larger than the original particle size before heat treatment by heat-treating the nanoparticles adsorbed on the porous material in a reducing atmosphere. These hard-magnetic nanoparticles adsorbed on the porous material can then be obtained as hard-magnetic nanoparticles without the porous material by removing the porous material, while also maintaining the particle size and hard magnetism.

Since the surface of the metal nanoparticles may have already been oxidized before the heat treatment or may be oxidized during the heat treatment, it is important that the heat treatment be in a reducing gas atmosphere. A reducing gas atmosphere can be created by mixing an inactive gas with a reducing gas. There are no particular limits on the reducing gas, which may be carbon monoxide or hydrogen for example. Hydrogen is preferred for practical purposes. The inactive gas may be nitrogen, argon or the like for example.

There are no particular limits on the other heat treatment conditions, but a pressure of 10⁻² to 10⁵ Pa and a temperature of 400 to 900° C. are preferred. Outside these ranges hard magnetization may be inadequate or the nanoparticles may aggregate.

Next, the porous material is dissolved in a liquid capable of dissolving the porous material, and then, the hard-magnetic nanoparticles are isolated from the porous material. There are no particular limits on the separation method, which can be selected appropriately from known methods such as centrifugation, extraction, funnel separation and the like. For example, the nanoparticles which are metal nanoparticles that have been made to be hard-magnetic by the aforementioned heat treatment can be placed together with the porous material in an aqueous solution capable of dissolving the porous material, after which this aqueous solution can be brought into contact with a water-insoluble liquid so that the hard-magnetic nanoparticles are transferred to the water-insoluble liquid, thereby providing a magnetic fluid of the hard-magnetic nanoparticles dispersed in the water-insoluble liquid. In this way, hard-magnetic nanoparticles from which the porous material has been removed can thus be obtained from hard-magnetic nanoparticles that have been adsorbed by a porous material. The water-insoluble liquid in this case is a liquid that is sufficiently water-insoluble so as to be capable of resulting in phase separation when it is present together with the aforementioned aqueous solution. In general, a nonpolar liquid such as a hydrocarbon or the like is desirable.

Unlike known hard-magnetic nanoparticles, the hard-magnetic nanoparticles obtained in this way do not grow in particle size even when subjected to heat treatment to bring about hard magnetism, and can be made as fine particles with an average particle size of 6 nm or less.

With hard-magnetic nanoparticles having an average particle size of 6 nm or less, transition noise is reduced due to the small particle size while a high magnetic anisotropic energy can be achieved by conferring hard magnetism. No magnetic fluid comprising hard-magnetic nanoparticles of this size having an ordered crystal structure has been known in the past. In the present invention, the “hard-magnetic nanoparticles” may be in any form. For example, hard-magnetic nanoparticles, a so-called magnetic fluid of hard-magnetic nanoparticles dispersed in a suitable solvent for purposes of application to magnetic recording media, and nanoparticles which have been applied to a magnetic recording medium so as to form part of the magnetic recording medium such as a recording layer of the magnetic recording medium all fall within the definition of “hard-magnetic nanoparticles” in the present invention.

There are no particular limits on the liquid capable of dissolving the porous material as long as it has this function, and it may be selected appropriately according to the porous material used. In general, an alkali aqueous solution of sodium hydroxide, potassium hydroxide or the like or an acid aqueous solution of hydrochloric acid, nitric acid, sulfuric acid, hydrofluoric acid or the like can be used. An alkali aqueous solution is preferred when a silica gel is used as the porous material, while an acid aqueous solution is preferred when a zeolite is used. Specifically, an aqueous solution of sodium hydroxide or hydrochloric acid can be used.

It is desirable to use an aqueous solution because it can then be brought into contact with a water-insoluble liquid such as hexane or another hydrocarbon, and the hard-magnetic nanoparticles can be easily transferred to the water-insoluble liquid.

Elements derived from the porous material may be present in the resulting magnetic fluid. These can be removed by additional purification according to the properties of the impurities, or such impurities may be allowed to remain to the extent that they do not affect the quality of the final magnetic recording medium.

The resulting magnetic fluid can be applied to a substrate to make a magnetic recording medium, either as it is or after application as necessary of such operations as first removing the hard-magnetic nanoparticles as a powder or highly-concentrated slurry for purposes of purification, re-dispersing them in a nonpolar liquid, changing the concentration, adding appropriate additives (dispersion stabilizers, viscosity adjusters, binders, etc.) and the like. A volatile hydrocarbon suited to the application method can be selected and used in this case as the nonpolar liquid.

When the metal nanoparticles of the present invention are made into hard-magnetic nanoparticles by heat treatment and subsequent treatment, they maintain strong hard magnetism and are prevented from growing in particle size, so that transition noise can be reduced due to the small particle size and a high magnetic anisotropic energy can be achieved because hard magnetism has been conferred. As a result, a high S/N ratio can be achieved with a magnetic recording medium using these hard-magnetic nanoparticles or a magnetic fluid. There are no particular limits on the shape or configuration of such a magnetic recording medium. Shapes include disk and tape magnetic recording media, while the magnetic recording may be of a perpendicular magnetic recording mode.

### EXAMPLES

Examples of the present invention are explained below based on the drawings.

### Example 1

First, a silica gel powder was added in a flask to an organic liquid (hexane) having chemically-synthesized FePt nanoparticles dispersed therein, stirred, and left for about 30 minutes to form a nanoparticle carrying body with metal nanoparticles adsorbed on the surface of a silica gel. The FePt nanoparticle synthesis method can be selected appropriately from known methods.

Preferably 10 parts by mass or more of the silica gel powder is added per 1 part by mass of the metal nanoparticles. If less than 10 parts by mass of the silica gel is added, the metal nanoparticles will stack up on the silica gel surface, and more particles are likely to become fused as a result of the aforementioned heat treatment (sometimes called ordering heat treatment hereunder). There is no particular upper limit on the amount of a silica gel added per 1 part by mass of the metal nanoparticles, but 400 parts by mass or less is desirable from the standpoint of efficient use of the silica gel and handling of the porous material that is a nanoparticle carrier.

Next, the organic solvent was evaporated, and the nanoparticle carrying body was transferred to a quartz crucible and subjected to ordering heat treatment. Ordering heat treatment was performed by heating for 30 minutes at a pressure of 5,000 Pa and a temperature of 550° C. in an Ar gas atmosphere containing 3% hydrogen by volume.

The ordering heat treatment caused the crystals of the FePt nanoparticles to alter from a disordered fcc structure into an ordered fct structure, producing strong magnetism in the metal nanoparticles to form hard-magnetic nanoparticles. The specific conditions for ordering heat treatment may be a hydrogen gas fraction of 1 to 7% by volume, a heating temperature of 400 to 900° C. and a heating time of 20 to 60 minutes.

Next, the nanoparticle carrying body was cooled and the hard-magnetic nanoparticles were removed. Specifically, the hard-magnetic nanoparticles were removed by adding a solution containing 1 g of sodium hydroxide (for dissolving the silica gel) in 5 mL of water to 200 mg of a nanoparticle carrying body consisting of hard-magnetic nanoparticles and a silica gel, and stirring to dissolve the silica gel, after which a solution containing 0.02 mL of oleic acid and 0.02 mL of oleylamine (dispersion stabilizer) in 5 mL of hexane was added and stirred to transfer the hard-magnetic nanoparticles to the hexane phase.

Next, the water phase was separated with a separation funnel, and ethanol in a volume equal to that of hexane phase was added to precipitate the hard-magnetic nanoparticles, followed by centrifugation, and the hard-magnetic nanoparticles obtained by removal of the supernatant were washed in ethanol to remove water and then dispersed in hexane to obtain a magnetic fluid of hard-magnetic nanoparticles dispersed in hexane.

The resultant hard-magnetic nanoparticles were subjected to x-ray analysis by 2 θ/θ scanning in an x-ray diffraction device. FIG. 2 shows the x-ray diffraction pattern of the ordered metal nanoparticles or in other words hard-magnetic nanoparticles. Looking at FIG. 2, the diffraction lines of the FePt fct structure appear in the (001) plane (2θ=23.80), (110) plane (32.9°), (111) plane (41.0°), (200) plane (47.2°), (002) plane (48.8°) and (201) plane (53.5°), showing that hard-magnetic nanoparticles having an fct structure were obtained. In FIG. 2, the diffraction line A is derived from the Si substrate. The coercive force of the hard-magnetic nanoparticles was 14.4 kOe at room temperature.

Observation under a transmission electron microscope revealed a monocrystalline body with a uniform lattice image.

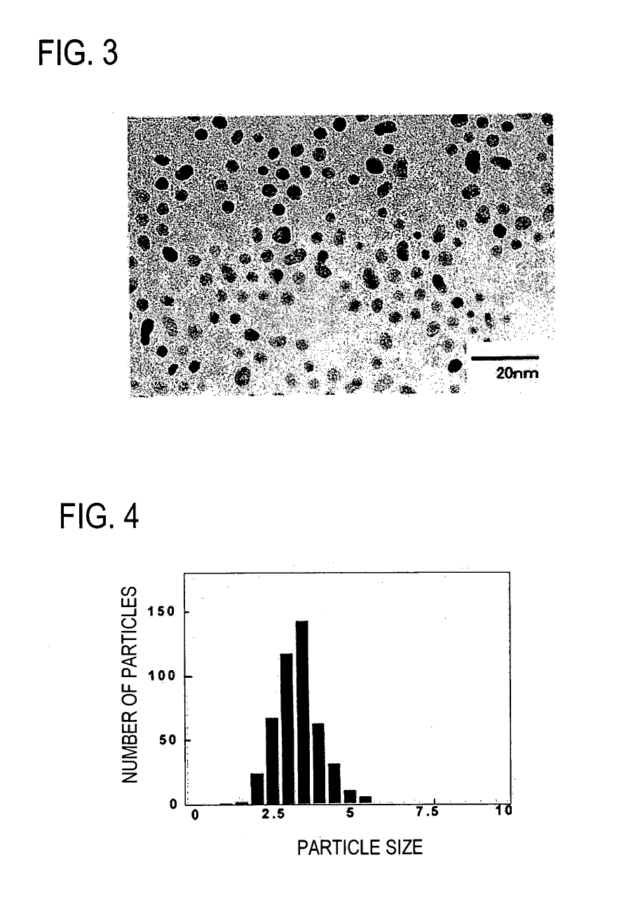

Next, the particle size of the FePt nanoparticles was analyzed. FIG. 3 is a transmission electron microscope image of the aforementioned FePt nanoparticles. In image analysis, when the particle size of the FePt nanoparticles was analyzed in a viewing field of 200×160 nm, the average particle size of the FePt nanoparticles before the ordering heat treatment was 3.7 nm (particle size variance 19%), while the average particle size of the FePt nanoparticles after the ordering heat treatment and removal was 3.8 nm (particle size variance 18%), showing that the particle size was maintained after the ordering heat treatment. FIG. 4 shows the particle size distribution of the hard-magnetic FePt nanoparticles as obtained by analysis of the electronic microscope image of FIG. 3.

A FePt nanoparticle film was prepared by drop deposition using these FePt nanoparticles. The compositional analysis of this FePt nanoparticle film with an electron beam microanalyzer in a 100 μm radius range revealed that the proportion of FePt in the sample ((Fe+Pt)/(Fe+Pt+Si)} was 51/100 (number of atoms/number of atoms).

### Example 2

In this example a zeolite was used instead of a silica gel in the ordering heat treatment step. A zeolite powder was added in a flask to an organic solvent (hexane) with FePt nanoparticles dispersed therein, stirred, and left for about 30 minutes to form a nanoparticle carrying body with the metal nanoparticles adsorbed on the zeolite surface. The zeolite here is preferably added in an amount of 10 or more parts by mass per 1 part by mass of the metal nanoparticles. If the zeolite is less than 10 parts by mass the metal nanoparticles will stack up on the zeolite surface, and more of the particles will become fused during the ordering heat treatment in some cases. The maximum amount of a zeolite added relative to 1 part by mass of the metal nanoparticles is not particularly limited but is preferably 400 parts by mass or less from the standpoint of efficient use of the zeolite and handling of the nanoparticle carrying body.

Next, the organic liquid was evaporated, and the nanoparticle carrying body was transferred to a quartz crucible and subjected to ordering heat treatment under the same conditions as in Example 1.

Next, the nanoparticle carrying body was cooled and the hard-magnetic nanoparticles were removed. Specifically, 2 mL of 2 percent by weight hydrochloric acid was added to 100 mg of the nanoparticle carrying body consisting of the hard-magnetic nanoparticles and zeolite, and stirred to dissolve the zeolite, after which a solution containing 0.1 μL of oleic acid and 0.1 μL of oleylamine in 2 mL of hexane was added and stirred to transfer the hard-magnetic nanoparticles to the hexane phase. Next, the water phase was separated with a separation funnel, and ethanol in a volume equal to that of hexane phase was added to precipitate the hard-magnetic nanoparticles, followed by centrifugation, and the hard-magnetic nanoparticles obtained by removal of the supernatant were washed in ethanol to remove the water. These were then dispersed in hexane to obtain a magnetic fluid of hard-magnetic nanoparticles dispersed in hexane.

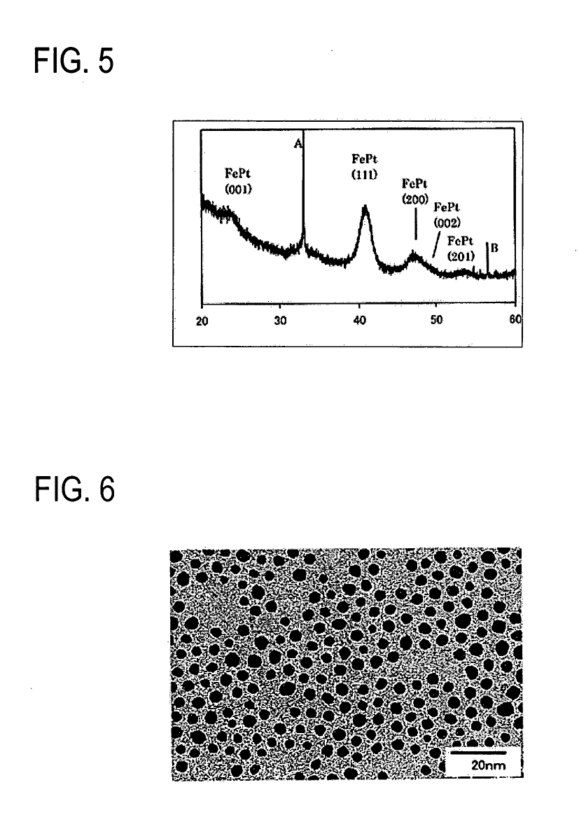

The resultant hard-magnetic nanoparticles were subjected to x-ray analysis by 2 θ/θ scanning in an x-ray diffraction device. FIG. 5 shows the x-ray diffraction pattern of the ordered metal nanoparticles or in other words hard-magnetic nanoparticles. Looking at FIG. 5, the diffraction lines of the FePt fct structure appear in the (001) plane (2θ=23.8°), (111) plane (41.0°), (200) plane (47.2°), (002) plane (shoulder of (200) plane) and (201) plane (53.5°), showing that hard-magnetic nanoparticles having an fct structure were obtained. In FIG. 5, diffraction line A is derived from the Si substrate, while diffraction line B is a noise. The coercive force of the hard-magnetic nanoparticles was 11.4 kOe at room temperature.

Observation under a transmission electron microscope revealed a monocrystalline body with a uniform lattice image.

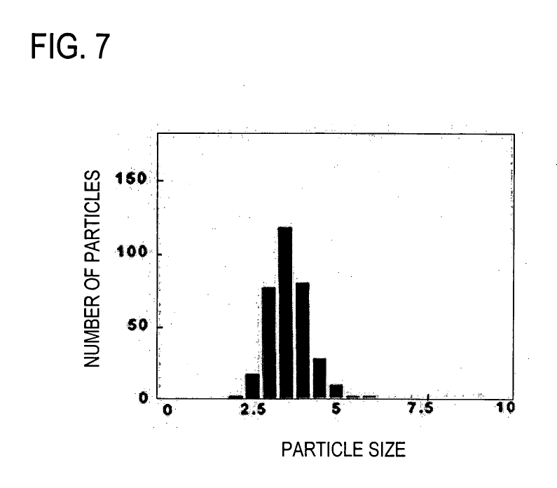

Next, the particle size of the FePt nanoparticles was analyzed. FIG. 6 is a transmission electron microscope image of the FePt nanoparticles of Example 2. In image analysis, when the particle size of the FePt nanoparticles was analyzed in a 200×160 nm rectangular viewing field, the average particle size of the FePt nanoparticles before the ordering heat treatment was 4.4 nm (particle size variance 13%), while the average particle size of the FePt nanoparticles after the ordering heat treatment and removal was 4.0 nm (particle size variance 14%), showing that the particle size had been maintained after the ordering heat treatment. FIG. 7 shows the particle size distribution of the hard-magnetic FePt nanoparticles as obtained by analysis of the electronic microscope image of FIG. 6.

When the composition of an FePt nanoparticle film prepared as in Example 1 was analyzed by an electron beam microanalyzer in a 100 μm radius range, the proportion of FePt in the sample {(Fe+Pt)/(Fe+Pt+Si+Al)) was 98/100 (number of atoms/number of atoms).

What is claimed is:

1. Hard-magnetic nanoparticles adsorbed on a porous material.

2. The hard-magnetic nanoparticles according to claim 1, comprising at least one material selected from the group consisting of FePt, FePd and CoPt.

3. Hard-magnetic nanoparticles obtained by removing said porous material from the hard-magnetic nanoparticles according to claim 1.

4. The hard-magnetic nanoparticles according to claim 3, the average particle size of which is 6 nm or less.

5. A method for manufacturing hard-magnetic nanoparticles, comprising:
causing metal nanoparticles to be adsorbed on a porous material;
heat-treating said metal nanoparticles in a reducing atmosphere; and then,
dissolving said porous material with a liquid capable of dissolving said porous material to isolate the hard magnetic nanoparticles from said porous material.

6. The method for manufacturing hard-magnetic nanoparticles according to claim 5, wherein said adsorption is caused by bringing a porous material into contact with metal nanoparticles dispersed in a liquid.

7. The method for manufacturing hard-magnetic nanoparticles according to claim 5, wherein the ratio of said porous material to said metal nanoparticles is 10 or more parts by mass of said porous material per 1 part by mass of said metal nanoparticles.

8. The method for manufacturing hard-magnetic nanoparticles according to claim 5, comprising:
placing said heat-treated metal nanoparticles together with the porous material in an aqueous solution capable of dissolving said porous material; and then,
bringing the aqueous solution into contact with a water-insoluble liquid to transfer said metal nanoparticles into said water-insoluble liquid.

9. The method for manufacturing hard-magnetic nanoparticles according to claim 5, wherein said metal nanoparticles are nanoparticles comprising at least one material selected from the group consisting of FePt, FePd and CoPt.

10. The method for manufacturing hard-magnetic nanoparticles according to claim 5, wherein said porous material is a silica gel.

11. The method for manufacturing hard-magnetic nanoparticles according to claim 5, wherein said porous material is a zeolite.

12. The method for manufacturing hard-magnetic nanoparticles according to claim 5, wherein said heat treatment is performed at a temperature of 400 to 900° C.

13. Hard-magnetic nanoparticles manufactured by a manufacturing method according to claim 5.

14. A magnetic fluid comprising hard-magnetic nanoparticles according to claim 1 dispersed in a nonpolar liquid.

15. A magnetic fluid comprising hard-magnetic nanoparticles according to claim 13 dispersed in a nonpolar liquid.

16. A magnetic recording medium obtained by applying hard-magnetic nanoparticles according to claim 1.

17. A magnetic recording medium obtained by applying hard-magnetic nanoparticles according to claim 13.
